(19) United States
(12) Patent Application Publication
(10) Pub. No.: US 2021/0255058 A1
(43) Pub. Date: Aug. 19, 2021

(54) DEVICES AND METHODS OF TESTING OPTICAL SYSTEMS

(71) Applicant: AFL Telecommunications LLC, Duncan, SC (US)

(72) Inventor: Fang Xu, Auburndale, MA (US)

(21) Appl. No.: 16/790,253

(22) Filed: Feb. 13, 2020

(51) Int. Cl. G01M 11/00

(52) U.S. Cl. CPC G01M 11/33; G01M 11/005; G01M 11/31

(57) ABSTRACT

A method of testing an optical network with a device, the method comprising transmitting a light pulse in a first direction from a light source of the device through the optical network toward an optical reflector, wherein the light pulse travels through the optical network in the first direction, is reflected by the reflector, and travels though the optical network in a second direction opposite the first direction after being reflected by the reflector; measuring a power level of the light pulse after the light pulse travels through the optical network in the second direction; determining a total loss of the light pulse in both the first direction and the second direction; and determining a loss of the optical network by subtracting a loss of the light pulse in the second direction only from the determined total loss of the light pulse.

### FIELD

The present disclosure relates generally to devices for and methods of testing optical systems, and more particularly to devices for and methods of testing several aspects of optical systems with high accuracy and efficiency.

### BACKGROUND

Testing of fiber optic cables and fiber optic networks generally requires multiple steps with different hardware, e.g., test instruments, used in different steps. Generally, a loss test is performed with a separate light source and power meter in one step and a map or trace of the fiber optic cable or network is captured with an optical time-domain reflectometer in another step.

Light source power meter methods are generally known and utilized in the fiber optics industry to measure the insertion losses of the optical fibers in fiber optic cables. Typically, a fiber optic cable, network, or other system under test may be connected between two test cables. One test cable is connected to a light source, and the other test cable is connected to a power meter. Light is transmitted from the light source through the test cables and fiber optic cable to the power meter, and the loss in an optical fiber of the fiber optic cable is determined based on the measured power at the power meter and the power measured by referencing the light source to the power meter directly.

A fiber optic network can be as short as a few meters or as long as tens of kilometers. Monitoring both ends, particularly, of multi kilometer fiber optic networks typically requires at least two people, as well as additional time and expenses associated therewith.

An optical time-domain reflectometer (“OTDR” or “device”) is typically connected to one end of an optical system (e.g., cable, network, etc.) under test and transmits pulsed light signals along the fiber. The optical time-domain reflectometer records reflected light as a function of time, called an OTDR trace or simply a trace. The trace is used by software to detect reflections, e.g., fiber backscattering of the pulsed light signals due to discontinuities or intensity changes within the optical system, such as connectors, breaks, splices, splitters, or bends in the optical fiber, generally called events. The optical time-domain reflectometer analyzes the detected reflected light signal with respect to time in order to locate such events along the length of the optical fiber. The results of such analysis may be output as a table of events of the optical device.

Further, optical time-domain reflectometers may be used to measure end-to-end loss of the optical system by comparing fiber backscatter levels at both ends. However, conventional methods of using an optical time-domain reflectometer to measure loss depends on accuracy of the fiber backscatter coefficients. Therefore, OTDR methods are less accurate than measuring loss using a separate light source and power meter on opposite ends of the optical system. Thus, as mentioned, complete and accurate testing of an optical system generally requires multiple steps with different test instruments used in different steps, e.g., loss testing with a light source and power meter and event tracing with an optical time-domain reflectometer.

Moreover, an OTDR trace captured on one side of the network is not a complete representation of the network under test. When light is transmitted from one section of fiber to another section, the trace can reflect the loss in addition to a backscatter coefficient of each section. To determine the true loss, an OTDR trace captured from opposite directions is needed. The true loss can then be calculated by averaging the values of the two different losses captured from both directions. However, and as previously described, this is typically more time consuming and expensive and requires people positioned at opposite ends of the network.

The use of separate test instruments or repetitive measurements is time consuming, cumbersome, and may result in damage to the optical connector on the fiber span under test and/or the test port optical connector.

Integrated versions of the two previously described methods use optical multiplexers to connect different test hardware sequentially in order to avoid manual switching of different test instruments. As previously noted, this requires at least two people to complete the job—a first person at a first end of the optical system and a second person at a second end of the optical system.

Accordingly, improved testing devices and methods for optical fibers are desired. In particular, testing devices and methods that reduce or eliminate the requirement for multiple separate instruments, eliminating the necessity of a second person, and that thus reduce the associated time and risk involved in such testing, would be advantageous.

### BRIEF DESCRIPTION

Aspects and advantages of the invention will be set forth in part in the following description, or may be obvious from the description, or may be learned through practice of the invention.

In accordance with one aspect, the present disclosure is directed to a method of testing an optical network with a device. The method includes determining a reference power. The method also includes connecting the device to the optical network at a first end of the optical network and connecting an optical reflector to the optical network at a second end of the optical network opposite the first end of the optical network. The method further includes transmitting a light pulse from a light source of the device through the optical network toward the optical reflector. The method also includes measuring a power level of a reflected light pulse reflected from the optical reflector through the optical network to the device. The method further includes determining a loss of the optical network based on the measured power level of the reflected light pulse and the reference power.

In accordance with another aspect, the present disclosure is directed to a method of testing an optical network with a device. The method includes transmitting a light pulse from a light source of the device through the optical network toward an optical reflector. The light pulse travels through the optical network, is reflected by the reflector, and travels backwards through the optical network. The method further includes measuring a power level of the light pulse transmitted through the optical network and the mirrored network. The method also includes determining a loss of the light pulse transmitted through the optical network and the mirrored network. The method further includes determining a loss of the optical network by determining half of the power difference of a reference power and the power of the light pulse after making a round trip in the network under test, e.g., through the network under test and the mirrored network.

In accordance with yet another aspect, the present disclosure is directed to a method of testing an optical network with a device. The method includes recording an OTDR trace of the optical network, with the device. The method also includes performing an optical loss test on the optical network with the device. The optical loss test may have an accuracy error at a comparable level to traditional methods, such as less than 0.1 dB.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a schematic illustration of a device configured to test an optical system in accordance with one or more exemplary embodiments of the present disclosure.

FIG. 2 provides a schematic illustration of a device configured to test an optical system connected to an optical reflector in accordance with one or more exemplary embodiments of the present disclosure.

FIG. 3 provides a schematic illustration of a device configured to test an optical system and an optical reflector each connected to opposite ends of an optical network in accordance with one or more exemplary embodiments of the present disclosure.

FIG. 4 provides a schematic illustration of a device configured to test an optical system connected to an optical reflector in accordance with one or more additional exemplary embodiments of the present disclosure.

FIG. 5 provides a schematic illustration of a device configured to test an optical system and an optical reflector each connected to opposite ends of an optical system in accordance with one or more additional exemplary embodiments of the present disclosure.

FIG. 6 illustrates a method of testing an optical system with a device in accordance with one or more exemplary embodiments of the present disclosure.

FIG. 7 illustrates a method of testing an optical system with a device in accordance with one or more exemplary embodiments of the present disclosure.

FIG. 8 illustrates a method of testing an optical system with a device in accordance with one or more exemplary embodiments of the present disclosure.

FIG. 9 provides a schematic illustration of a dust cap connected to an optical fiber of an optical system in accordance with one or more exemplary embodiments of the present disclosure.

FIG. 10 illustrates a method of testing an optical system with a device in accordance with one or more exemplary embodiments of the present disclosure.

### DETAILED DESCRIPTION

Reference now will be made in detail to embodiments of the invention, one or more examples of which are illustrated in the drawings. Repeat use of reference characters in the present specification and drawings is intended to represent the same or analogous features or elements of the present invention. Each example is provided by way of explanation of the invention, not limitation of the invention. In fact, it will be apparent to those skilled in the art that various modifications and variations may be made in the present invention without departing from the scope or spirit of the invention. For instance, features illustrated or described as part of one embodiment may be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and do not necessarily signify sequence or importance of the individual components. As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

As used herein, the term “direction” refers to the direction of light travelling from the light source with respect to the media of transmission. In this regard, light travelling in a first direction includes light travelling along the media of transmission before hitting a reflector, such as a mirror, a fiber break, an open UPC connector, or even a micro structure of the transmission media itself. Light travelling in a second direction includes light travelling along the media of transmission after hitting the reflector. The “direction” does not change according to the shape of the transmission media. For instance, the direction does not change when the optical fiber is bent.

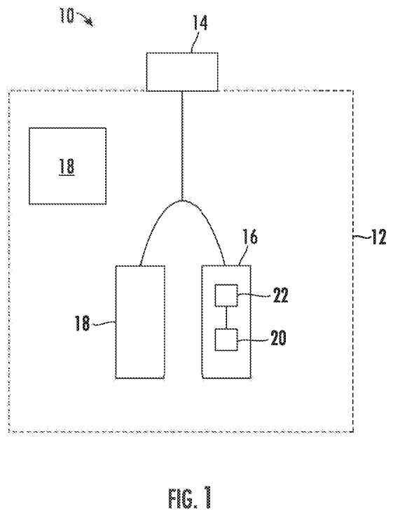

Referring now to the Figures, the present disclosure is generally directed to methods and devices which advantageously facilitate improved testing of optical systems, such as one or more optical fibers or fiber optic networks containing multiple optical fibers, including an exemplary device 10 and methods of using the device 10 for complete testing of the optical system(s). Referring to FIG. 1, for example, the device 10 may include a casing or housing 12 with a light source 16 and a measurement element 18 configured to make a measurement of light within the optical system. In an embodiment, the light source 16 and measurement element 18 are disposed within the housing 12. The light source 16 and measurement element 18 may be connected to a test port 14 by an optical branching device (which may for example include a splitter and/or other suitable device, such as optical fiber couplers, circulator, etc., for providing such branching). Thus, the light source 16 and the measurement element 18 are both in optical communication with the test port 14 of the device 10 via the optical branching device. As illustrated for example in FIG. 1, the test port 14 may be at least partially external to the housing 12. The test port 14 may be a contact-based port or contactless port, and a suitable connector of a suitable cable as discussed herein may be connected to the port to facilitate optical coupling with the device 10. In at least some embodiments, the light source 16 may include a pulse generator 20 and a laser 22 which is driven by the pulse generator 20 such that the light source 16 may be operable to emit light pulses as is generally understood in the art. In some embodiments, the measurement element 18 of the device 10 may include an optical power meter with an avalanche photodiode, as is understood by those of ordinary skill in the art.

The device 10 may further include a controller 24. The controller 24 may be in communication with other components of the device 10, including the light source 16 and the measurement element 18. The controller 24 may be configured and operable to cause such other components to perform the various operations and method steps as discussed herein.

Controller 24 may generally comprise a computer or any other suitable processing unit. For example, the controller 24 may include one or more processor(s) and associated memory device(s) configured to perform a variety of computer-implemented functions, as discussed herein. As used herein, the term “processor” refers not only to integrated circuits referred to in the art as being included in a computer, but also refers to a controller, a microcontroller, a microcomputer, a programmable logic circuit (PLC), an application specific integrated circuit, and other programmable circuits. Additionally, the memory device(s) of the controller 24 may generally comprise local memory element(s) including, but are not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements including remote storage, e.g., in a network cloud. Such memory device(s) may generally be configured to store suitable computer-readable instructions that, when implemented by the processor(s), configure the controller 24 to perform various computer-implemented functions including, but not limited to, performing the various steps discussed herein. In addition, the controller 24 may also include various input/output channels for receiving inputs from and for sending control signals to the various other components of the device 10, including the light source 16 and the measurement element 18.

In various embodiments, the present disclosure is directed to methods of testing an optical system including one or more optical fibers, such as a fiber optic cable or a fiber optic network (e.g., a network comprising one or more cables, at least some of which are fiber optic cables) with a testing device. It should be understood that in exemplary embodiments, the controller 24 may be utilized to perform some or all of the various method steps as discussed herein.

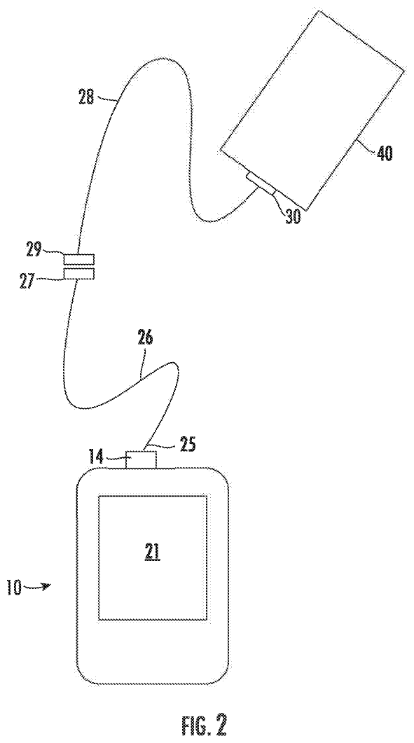

Turning now to FIG. 2, the device 10 may further include a display 21. As shown in FIG. 2, the device 10 may be connected to an optical reflector 40 for measuring or determining a reference power after attenuation of a round trip without network under test of light emitted by the device 10 and received by the same device 10. In various embodiments, the optical reflector 40 may be, e.g., a mirror, an open UPC connector, or any other suitable optical reflector. The optical reflector can be reflective for all wavelengths or reflective only to selected wavelengths.

For example, the reference power may be determined when the device 10 is connected to the optical reflector 40, e.g., when the device 10 is connected to the optical reflector 40 without a network under test between the device 10 and the optical reflector 40. As shown in FIG. 2, the device 10 may be connected to the optical reflector 40 by a launch cable 26 and a receive cable 28. More specifically, a first end 25 of the launch cable 26 may be connected to the test port 14 of the device 10, a second end 27 of the launch cable 26 may be connected to a second end 29 of the receive cable 28, and a first end 30 of the receive cable 28 may be connected to the optical reflector 40. In particular, the first end 25 of the launch cable 26 may be directly connected to the device 10, the first end 30 of the receive cable 28 may be directly connected to the optical reflector 40, and the second end 27 of the launch cable 26 may be directly connected to the second end 29 of the receive cable 28.

With the device 10 and the optical reflector 40 so connected, the reference power of the device 10 may be obtained by emitting one or more light pulses into the cables 26 and 28, e.g., from the light source 16 of the device 10 through the test port 14 such that the light pulse(s) are transmitted from the light source 16 of the device 10 through the cables, e.g., launch cable 26 and receive cable 28, to the optical reflector 40, and measuring an optical power level of the reflections of such light pulse(s) from the optical reflector 40 with the optical power meter 18 of the device 10.

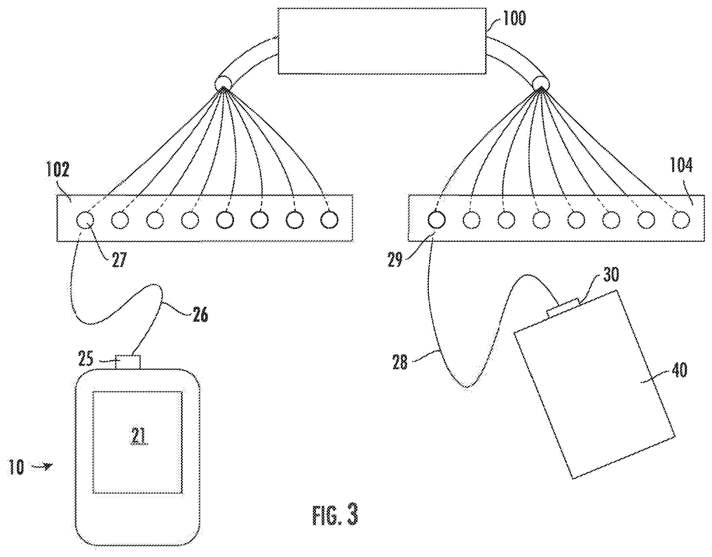

Turning now to FIG. 3, the device 10 may be connected to an optical network under test (sometimes abbreviated NUT) 100 at a first end 102 of the optical network 100 and the optical reflector 40 may be connected to the optical network 100 at a second end 104 of the optical network 100. For example, as illustrated schematically in FIG. 3, the first and second ends 102 and 104 of the optical network 100 may be access panels at separate locations, such as separate ends, of the optical network 100. In some embodiments, the second end 104 of the optical network 100 may be opposite the first end 102 of the optical network 100. In some embodiments, connecting the device 10 to the optical network 100 at the first end 102 of the optical network 100 may include connecting the second end 27 of the launch cable 26 directly to the first end 102 of the optical network 100 and connecting the optical reflector 40 to the optical network 100 at the second end 104 of the optical network 100 may include connecting the second end 29 of the receive cable 28 directly to the second end 104 of the optical network 100.

As mentioned above, the optical reflector 40 may, in various example embodiments, include a mirror or an open UPC connector. For example, in some embodiments the optical network 100 may be a high-loss network and the optical reflector 40 may be a mirror. As another example, in other embodiments, the optical network 100 may be a low-loss network and the optical reflector 40 may be an open UPC connector. It should be understood that, as used in the foregoing, the relative terms “high-loss” and “low-loss” are used with reference to one another.

With the device 10, the optical reflector 40, and the optical network 100 configured and arranged, e.g., interconnected, as illustrated in FIG. 3, a return power may be obtained, e.g., the return power through the optical network 100 may be measured or determined when the device 10 and the optical reflector 40 are connected to the optical network 100 as shown in FIG. 3. As is generally understood in the art, the return power may include a measured power level of a reflected light pulse returned to the device 10 through the optical network 100 by the optical reflector 40.

In various embodiments, determining the return power may include transmitting one or more light pulses from the light source 16 (FIG. 1) of the device 10 through the optical network 100 to the optical reflector 40, and measuring a power level of one or more reflected light pulses reflected from the optical reflector 40 through the optical network 100 to the device 10 with the optical power meter 18 (FIG. 1) of the device 10.

Once the reference power has been obtained, e.g., using the configuration shown in FIG. 2 and described above, and the return power has been obtained, e.g., using the configuration shown in FIG. 3 and described above, the loss of the optical network 100 may be determined based on the reference power and the return power. For example, the loss of the optical network 100 may be based on a difference (AP) between the reference power and the return power. For example, in some embodiments, AP may be determined by subtracting the return power from the reference power. In some embodiments, the loss of the optical network 100 may be determined by subtracting the return power, e.g., the measured power level of the reflected light pulse, from the reference power and dividing the result of subtracting the measured power level of the reflected light pulse from the reference power by two. In such embodiments, the loss of the optical network 100 may also be expressed mathematically as:

Loss of NUT=½·ΔP

Additionally, in at least some embodiments, a trace of the optical network 100 may also be captured using the device 10, e.g., after determining the loss of the optical network 100. For example, the trace of the optical network 100 may be captured using the device 10 without disconnecting the device 10 from the optical network 100. Methods of capturing a trace of an optical network with an optical time-domain reflectometer are generally understood by those of ordinary skill in the art and, as such, are not described in greater detail herein. Nonetheless, it should be appreciated that testing methods according to the present disclosure may be advantageous in that the trace may be captured and a loss of the optical network may be determined using a single device, e.g., device 10, without the need to connect and disconnect multiple test instruments, e.g., without a separate light source and power meter for loss testing.

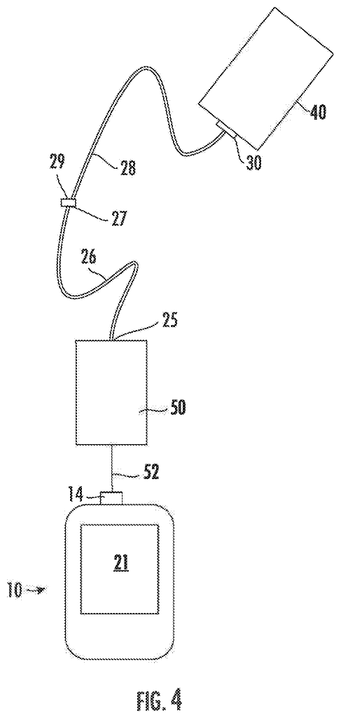

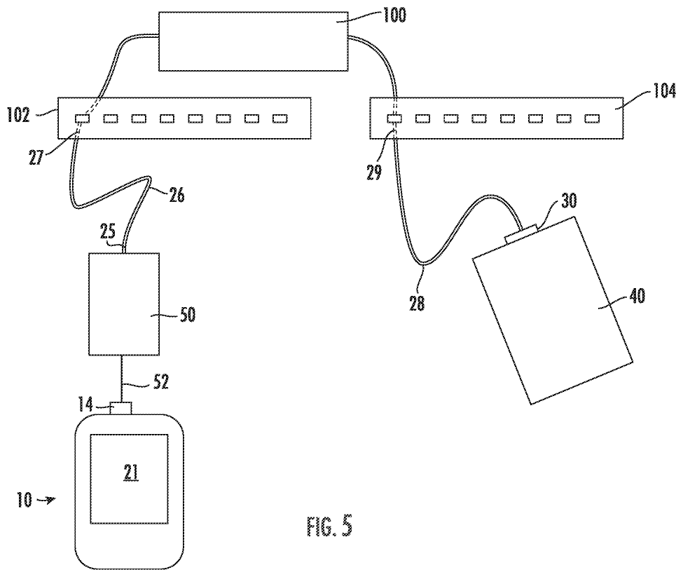

In some embodiments, the cables, e.g., the launch cable 26 and the receive cable 28, may be single-fiber cables, each of which includes only a single optical fiber, for example as illustrated in FIGS. 2 and 3. In these embodiments, the cables will include single-fiber connectors as are understood by those of ordinary skill in the art. In other embodiments, as illustrated in FIGS. 4 and 5, the cables 26 and 28 may be multiple-fiber cables each of which includes a plurality of optical fibers. In these embodiments, the cables may include multiple-fiber connectors, such as Multiple-Fiber Push-On (“MPO”) connectors.

In multiple-fiber embodiments, additional components may be included to facilitate the various connections. For example, as shown in FIG. 4, in embodiments where the cables 26 and 28 are multi-fiber cables, the device 10 may be connected to the MPO launch cable 26 through a multiplexer 50 and a jumper cable 52. The jumper 52 may be a single-fiber cable and the multiplexer 50 may facilitate an operative connection of the test port 14 and the single-fiber jumper 52 with the multiple fibers within the multi-fiber launch cable 26 in this embodiment.

One of skill in the art will recognize that an MPO cable is a multi-fiber cable having at least one MPO connector, and that such cables are but one example of possible multi-fiber cables usable with various embodiments of the present disclosure.

Other than the addition of the jumper cable 52 and the multiplexer 50, the configuration and operation of the device 10 and the optical reflector 40 shown in FIGS. 4 and 5, as well as the optical network 100 shown in FIG. 5, is generally the same as described above with respect to FIGS. 2 and 3. In order to shorten test time, N identical sets of test hardware can be used, so M fibers can be test in N groups simultaneously using N multiplexers. The multiplexers can have a ratio of at least M/N.

For example, the reference power may be obtained with the configuration depicted in FIG. 4 and may include transmitting one or more light pulses from the light source 16 of the device 10 to the optical reflector 40 without an optical network under test between the device 10 and optical reflector 40, e.g., with the device 10 and the optical reflector 40 connected by the launch cable 26 and receive cable 28 as described above with respect to FIG. 2, with the exception that the jumper cable 52 may be directly connected to the test port 14 and directly connected to the multiplexer 50, and the first end 25 of the launch cable 26 may be directly connected to the multiplexer 50. Accordingly, in such embodiments, the first end 25 of the launch cable 26 may be indirectly connected to the device 10, e.g., via the multiplexer 50 and the jumper cable 52. Thus, the reference power may be determined by measuring an optical power of one or more reflected light pulses received by the device 10 from the optical reflector 40 without an optical network therebetween, e.g., when the device 10 and optical reflector 40 are connected only by the cables 26, 28, and 52, and the multiplexer 50. In certain instances when a multiplexer is used, each branch can have a separated reference power level.

As another example, the return power may be obtained or determined using the configuration illustrated in FIG. 5 in a similar manner as described above with respect to FIG. 3. Further, the loss of the optical network 100 may then be obtained based on the reference power and the return power determined using the configurations of FIGS. 4 and 5. For example, the same mathematical relationship described above may be used, e.g., Loss of NUT=½·ΔP. It should be noted that the reference power and the return power used to determine ΔP are generally equivalent, such that the only change from the configuration used to determine the reference power to the configuration used to determine the return power is the presence of the optical network 100 (or at least a portion thereof) between the device 10 and the optical reflector 40. For example, the reference power obtained according to the configuration of FIG. 2 would be used with the return power obtained according to the configuration of FIG. 3 and the reference power obtained according to the configuration of FIG. 4 would be used with the return power obtained according to the configuration of FIG. 5.

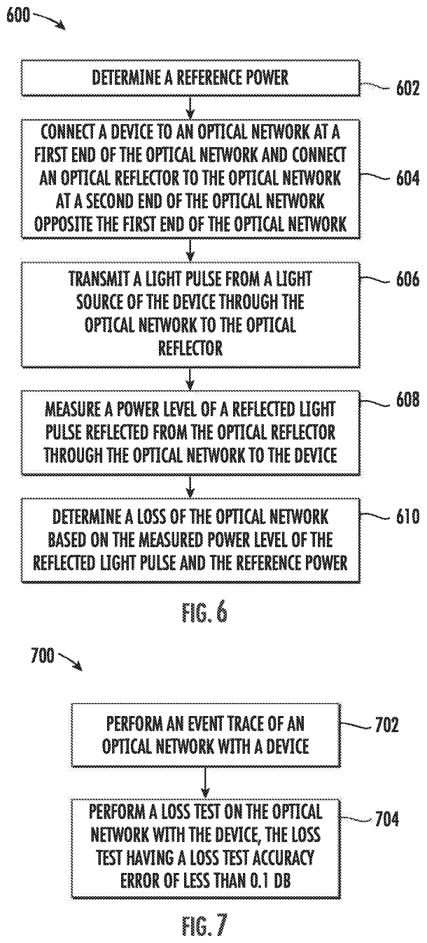

FIG. 6 illustrates one exemplary method 600 of testing an optical network with a device, such as the device 10 shown and described herein. As shown in FIG. 6, the method 600 may include a step of determining a reference power. For example, the reference power determined at step 602 may be the reference power of the device 10 described above with reference to FIG. 2 or FIG. 4. In some embodiments, determining the reference power may include connecting the device to the optical reflector, e.g., without the optical system therebetween as illustrated in FIG. 2 or FIG. 4. Determining the reference power may also include transmitting a light pulse from the light source of the device to the optical reflector and measuring a power level of a reflected light pulse reflected from the optical reflector to the device while the device and optical reflector are so connected.

Turning again to FIG. 6, the method 600 may also include determining a return power through the optical network. For example, the method 600 may include a step 604 of connecting the device, e.g., device 10, to an optical network at a first end of an optical fiber of the optical network and connecting an optical reflector to the optical network at a second end of the optical fiber opposite the first end of the optical fiber, a step 606 of transmitting a light pulse from a light source of the device through the optical network to the optical reflector, and a step 608 of measuring a power level of a reflected light pulse reflected from the optical reflector through the optical network to the device.

The method 600 may further include a step 610 of determining a loss of the optical network based on the measured power level of the reflected pulse and the reference power. As mentioned above, the loss of the optical network may be based on a difference of the measured power level of the reflected light pulse from the reference power. For example, the loss of the optical network may be determined by subtracting the measured power level of the reflected light pulse from the reference power and dividing the result of subtracting the measured power level of the reflected light pulse from the reference power by two.

FIG. 7 illustrates another exemplary method 700 of testing an optical network with a device, such as for example, the device 10 shown and described herein. The method 700 may include a step 702 of performing a trace of an optical network with the device. The method may also include a step 704 of performing a loss test on the optical network with the device. The performed loss test may have a loss test accuracy error of less than 0.1 dB, such as less than 0.08 dB, such as less than 0.06 dB, such as less than 0.05 dB, such as less than 0.04 dB, such as less than 0.03 dB. As used herein, the loss test accuracy error may measure an amount of error resulting from the herein described method of testing the optical system. The measured return loss may be calculated by comparing the measured loss to actual loss in the optical network, e.g., as measured by a known, calibrated device such as a power meter with a separate light source. The known, calibrated device may be deployed to test the optical system by positioning the power meter on a first end of the optical system and the separate light source on the opposite side of the optical system. In certain instances, the lost test accuracy error of the loss test may be caused at least in part by an optical reflector used for performing the loss test. More specifically, the loss test accuracy error may be caused at least in part by a loss incurred by the optical reflector. It is noted that traditional loss testing performed with optical time-domain reflectors (OTDR) return optical loss test values in excess of 0.1 dB as OTDR devices are not ideally equipped to accurately measure the loss in an optical system. Moreover, traditional loss tests are performed using light sources and power meters disposed on opposite sides of the optical fiber being measured, thus requiring use of multiple devices, such as multiple active devices, e.g., a separate power meter and light source setup.

In an embodiment, the device used to perform the method 700 may be further configured to perform a length test to determine the length of one or more optical fibers in the optical network. The device may perform the trace, optical loss test, and length test all while remaining connected with the optical network, e.g., throughout each operation and without disconnecting.

In an embodiment, the device used to perform the method 700 may remain connected to the optical network between and during the step 702 of performing the trace and the step 704 of performing the optical loss test. In this regard, the device may not be swapped with another device. In a further embodiment, the method 700 may be performed in its entirety without requiring switching of optical pathways, e.g., using an optical switch. In such a manner, the device 10 used in accordance with embodiments described herein may include a discrete, single-unit device, i.e., not a power meter and separate light source positioned on opposite ends of the optical fiber of the optical network.

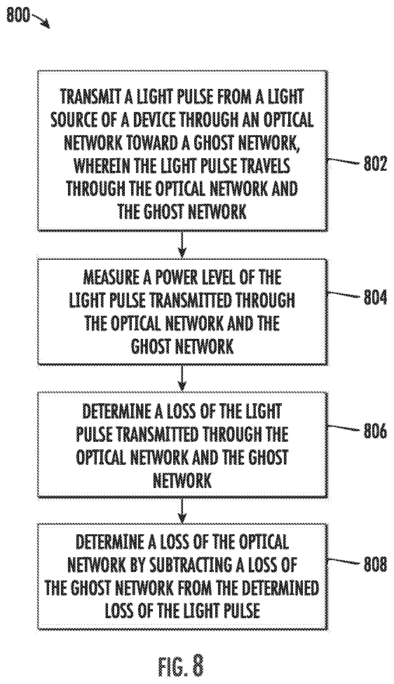

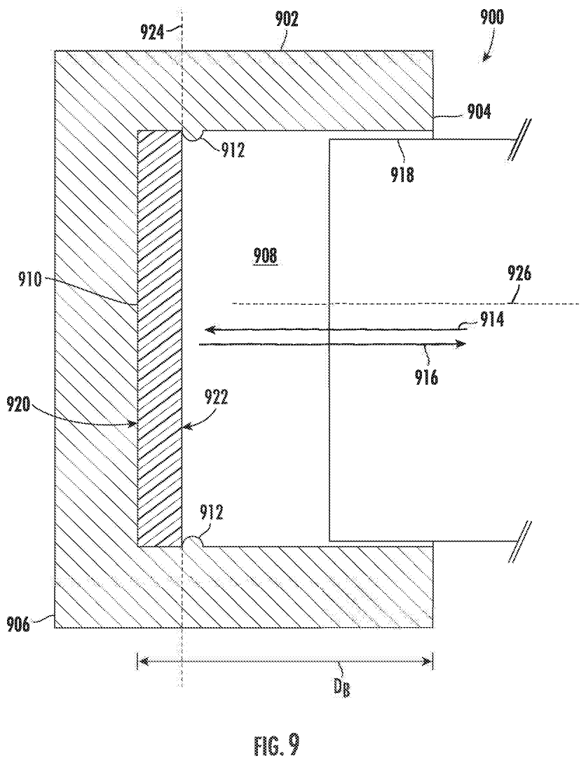

FIG. 8 illustrates yet a further example method 800 of testing an optical network with a device, such as for example, the device 10 shown and described herein. The method 800 may include a step 802 of transmitting a light pulse from a light source of the device through an optical network toward a reflector. The light pulse may travel through the optical network, reflect off the reflector, and travel backwards through the optical network, e.g., through a “ghost network” corresponding to the optical network in the reverse direction. After travelling through the ghost network, the light has the same characteristics as if it was transmitted from a ghost light source or virtual light source identical to the one in the device. The light travels through the ghost network identical to the network under test, e.g., the network under test in reverse, and arrives at the device travelling in the opposite direction as compared to when it arrived the first time. In a particular embodiment, the light pulse may travel through the entire length of the optical network twice, i.e., once in a first direction and once in a second direction opposite the first direction. In one or more embodiments, the optical network and the ghost network may be interposed by an optical reflector. That is, for example, an optical reflector may be disposed at an end of the optical network. For instance, the device may be disposed on a first end of an optical fiber of the optical network. The optical reflector may be disposed on a second end of the optical fiber opposite the first end of the optical fiber. The light pulse may travel from the first end of the optical fiber, e.g., from the device, through the optical network to the optical reflector. The light pulse from the optical network may be reflected by the optical reflector and travel along the ghost network, i.e., the optical network in the reverse direction. The ghost network may then transmit the light pulse to a device, such as the device used to transmit the light pulse.

In one or more embodiments, the optical network and the ghost network are part of a same optical fiber of an optical network. For example, the light pulse traveling on the optical network may include light traveling in a first direction along the optical fiber and the light pulse traveling on the ghost network may include light traveling in a second direction along the optical fiber, the second direction being opposite the first direction.

The method 800 may further include a step 804 of measuring a power level of the light pulse transmitted through the optical network and the ghost network. In an embodiment, transmitting the light pulse and measuring the power level of the light pulse may be performed at the same end of the optical fiber. For example, measuring the power level of the light pulse may be performed at the first end of the optical fiber as described with respect to step 802.

The method 800 may also include a step 806 of determining a loss of the light pulse transmitted through the optical network and the ghost network. Determining the loss of the light pulse may be performed by subtracting the power level of the light pulse as measured at step 804 from a reference power of the light pulse, as previously described.

As the ghost network is identical to the network under test, the method 800 may further include a step 808 of determining a loss of the optical network by subtracting a loss of the ghost network from the determined loss of the light pulse. In an embodiment, subtracting the loss of the ghost network may be performed by subtracting a known loss of the ghost network from the determined loss of the light pulse. In another embodiment, subtracting the loss of the ghost network may be performed by dividing the loss of the light pulse by two. This may be particularly suitable where the optical network and the ghost network have equal losses, such as when the optical network and ghost network are part of a same optical fiber with the light pulse along the optical network traveling in a first direction and the light pulse along the ghost network traveling in a second direction opposite the first direction.

In an embodiment, the light pulse can be utilized after reaching the reflector as if it was emitted by a virtual optical source disposed on the reflector side of the optical network. The light pulse from the virtual optical source can travel towards the instrument from the reflector. Reflection and backscatter of the virtual optical source travel from a device side of the optical network to the reflector side. The method further includes recording the previous reflections and backscatter after they hit the reflector and arrive back at the device. The method can further include virtually placing an OTDR in place of the reflector and obtaining a second OTDR trace in addition to the first OTDR trace. The method can further include performing a second OTDR trace virtually captured from the reflector side. The method can then include calculating the average value of loss from a same event in the first and second OTDR traces.

In an embodiment, the present disclosure can include a method of testing an optical network, including connecting a device to the optical network at a first end of the optical network and connecting an optical reflector to the optical network at a second end of the optical network opposite the first end of the optical network. The method can further include transmitting a light pulse from a light source of the device through the optical network toward the optical reflector. The method can further include recording reflection or backscatter of the light pulse coming back from the network under test as a function of time until the light pulse makes a round trip inside the network to accomplish a first OTDR trace.

The present disclosure can further include utilizing the power of a light pulse after making a round trip in the network under test to calculate network loss as indicated.

In accordance with another aspect, the present disclosure is directed to utilizing the light pulse after reaching the reflector as it was emitted by a virtual optical source. The light pulse from the virtual optical source travels towards the instrument from the reflector. Reflection and backscatter of the virtual optical source travel from a device side of the optical network to the reflector side. The method further includes recording the previous reflections and backscatter after they hit the reflector and arrive at the device. The method can further include virtually placing an OTDR in place of the reflector and obtaining a second OTDR trace in addition to the first OTDR trace. The method can further include performing a second OTDR trace virtually captured from the reflector side. The method can then include calculating the average value of loss from a same event in the first and second OTDR traces.

FIG. 9 illustrates an exemplary embodiment of a dust cap 900 in accordance with one or more embodiments described herein. Dust caps may be used to cover terminal ends of optical fibers to prevent contaminants from causing damage to fiber ends. Dust caps may be used with a wide array of optical fibers and connector types, including SC, LC, FC, ST, and/or MTP/MPO type connectors. Dust caps 900 in accordance with one or more exemplary embodiments described herein may additionally include optical reflectors, as described herein in greater detail, to perform analysis on the optical fibers.

The dust cap 900 may include a body 902 including a first end 904 and a second end 906. A bore 908 may extend from the first end of the body 902 toward the second end 906 of the body 902. In an embodiment, the bore 908 may extend less than an entire distance between the first and second ends 904 and 906. For instance, the bore 908 may define a depth, DB, less than 99% a length of the body 902, as measured between the first and second ends 904 and 906, such as less than 95% the length of the body 902, such as less than 90% the length of the body 902, such as less than 75% the length of the body.

The dust cap 900 may be connected to a longitudinal end of an optical fiber 918. Alternatively, the dust cap 900 may be engaged with a fiber optic adapter (not illustrated), such as an adapter used at the longitudinal end of the optical fiber 918. In the illustrated embodiment, the longitudinal end of the optical fiber 918 is illustrated spaced apart from an optical reflector 910 of the dust cap 900. It should be understood that in other embodiments the optical reflector 910 may contact the longitudinal end of the optical fiber 918. Moreover, the dimensional spacing between the longitudinal end of the optical fiber 918 and optical reflector 910 may be relatively different than as depicted in FIG. 9.

In an embodiment, the optical reflector 910 may be disposed at least partially within the bore 908 of the dust cap 900. In the illustrated embodiment, the optical reflector 910 is depicted at an end of the bore 908. That is, a rear surface 920 of the optical reflector 910 contacts the body 902 of the dust cap 900. In another embodiment, the rear surface 920 of the optical reflector 910 may be spaced apart from the body 920 of the dust cap 900.

In an embodiment, the optical reflector 910 may be configured to reflect at least 90% of the light incident upon a reflecting surface 922 of the optical reflector 910, such as at least 95% of the light incident upon the reflecting surface 922, such as at least 99% of the light incident upon the reflecting surface 922, such as at least 99.9% of the light incident upon the reflecting surface 922. The optical reflector 910 may have an optical loss of less than 0.1 dB of light reflected from the optical fiber, such as less than 0.05 dB of light reflected from the optical fiber, such as less than 0.02 dB of light reflected from the optical fiber.

In a particular embodiment, the optical reflector 910 may be or include a mirror. The reflecting surface 922 may define any surface shape or features suitable for light reflecting function. For instance, in an embodiment, the reflecting surface 922 may be generally flat. The reflecting surface 922 of the optical reflector 910 may be disposed along a best fit plane 924 generally perpendicular to an axis 926 of the bore 908. In such a manner, light 914 from the optical fiber 918 may be reflected 916 with minimal loss. In an embodiment, the reflecting surface 922 may define an arcuate contour. The arcuate contour may be, for example, concave. In certain instances, the reflecting surface 922 defines a shape to mate flush, or generally flush, with an end of the optical fiber adjacent thereto.

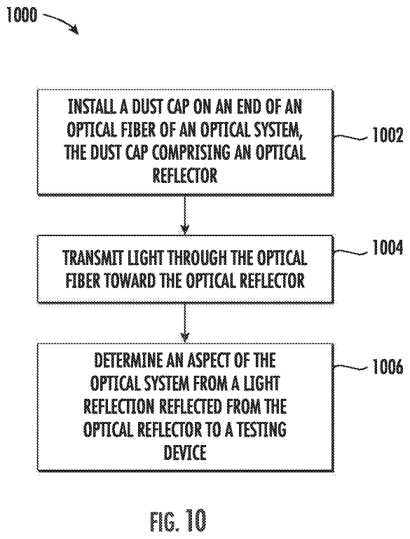

FIG. 10 illustrates an exemplary method 1000 of testing an optical system. The method 1000 includes a step 1002 of installing a dust cap on an end of an optical fiber of an optical system. This step 1002 may be performed at a much earlier time as compared to ensuing steps, e.g., during an initial installation of the optical fiber. The dust cap includes an optical reflector, such as the optical reflector 910 described above. In certain instances, the dust cap may be connected directly to the optical fiber. In other instances, the dust cap may be connected to a fiber optic adapter disposed between the optical fiber and the dust cap. In an embodiment, the method 1000 may include adjusting the orientation of the dust cap to generally align the optical reflector perpendicular with respect to the longitudinal axis of the optical fiber.

The method 1000 further includes a step 1004 of transmitting light through the optical fiber toward the optical reflector. The transmitted light may include pulsed light. For instance, the light may be generated by a laser connected to a pulse generator. The light may transmit pulsed signals through the optical system.

The method 1000 further includes a step 1006 of determining an aspect of the optical system from a light reflection reflected from the optical reflector to a testing device. The determined aspect of the optical system may include a loss test, a trace, a length test, or any other suitable test. After testing is complete, the dust cap may be removed from the optical system.

In light of the foregoing, it should be understood that the device used for testing optical networks in the various embodiments of the present disclosure is different from a traditional light source power meter loss setup. Specifically, traditional light source power meter loss setups are capable of performing only loss tests. These traditional setups are incapable of performing, for example, event tracing testing in an optical network. Moreover, it should be understood that the device used for testing optical networks in the various embodiments of the present disclosure is different from a traditional OTDR setup as far as its optical loss detection capability and low accuracy error. Specifically, OTDR setups are incapable of measuring optical loss with low accuracy error. Thus, technicians and line operators are traditionally required to carry both light source power meter loss setups and OTDR setups when performing complex functions on the optical network. Such requirements increase cost and time of network testing. Moreover, for large optical networks, traditional light source power meter loss setups require operators on both sides of the optical fiber. The methods associated with the device described herein in accordance with one or more embodiments may be performed by a single technician. Specifically, by using an optical reflector, the technician may perform all activities associated with optical testing at a single end of the optical fiber, thereby eliminating the need for additional technicians.

Those of ordinary skill in the art will appreciate that testing methods described herein provide numerous advantages over the prior art. For example, the loss measurement methods of the present disclosure may provide a better accuracy due to the division by two in the loss calculation, which reduces any hardware impairment by a factor of two. As another example, the present methods are less dependent on the backscatter coefficient of the optical fiber as compared to traditional OTDR methods.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of testing an optical network with a device, the method comprising:
determining a reference power;
connecting the device to the optical network at a first end of the optical network and connecting an optical reflector to the optical network at a second end of the optical network opposite the first end of the optical network;
transmitting a light pulse from a light source of the device through the optical network toward the optical reflector;
measuring a power level of a reflected light pulse reflected from the optical reflector through the optical network to the device; and
determining a loss of the optical network based on the measured power level of the reflected light pulse and the reference power.

2. The method of claim 1, further comprising performing a trace of the optical network with the device.

3. The method of claim 1, wherein the device is not disconnected from the optical network between or during the steps of determining the loss of the optical network and capturing the trace of the optical network.

4. The method of claim 1, wherein the optical reflector is a mirror for high-loss networks, an open UPC connector for low-loss networks, or a reflector with controlled loss.

5. The method of claim 1, wherein loss of the optical network is determined by subtracting the measured power level of the reflected light from the reference power level and dividing the result of subtracting the measured power from the reference power by two.

6. A method of testing an optical network with a device, the method comprising:
transmitting a light pulse in a first direction from a light source of the device through the optical network toward an optical reflector, wherein the light pulse travels through the optical network in the first direction, is reflected by the reflector, and travels though the optical network in a second direction opposite the first direction after being reflected by the reflector;
measuring a power level of the light pulse after the light pulse travels through the optical network in the second direction;
determining a total loss of the light pulse in both the first direction and the second direction; and
determining a loss of the optical network by subtracting a loss of the light pulse in the second direction only from the determined total loss of the light pulse.

7. The method of claim 6, wherein the light pulse travels through an entire length of the optical network and an entire length of the ghost network prior to measuring the power level of the light pulse.

8. The method of claim 6, wherein the light pulse traveling on the ghost network comprises light traveling along the optical network in a second direction opposite the first direction.

9. The method of claim 6, wherein transmitting the light pulse and measuring the power level of the light pulse are performed at a same end of an optical fiber of the optical network.

10. The method of claim 6, wherein the optical network and the ghost network are interposed by an optical reflector.

11. The method of claim 6, wherein the loss of the optical network is equal to the loss of the ghost network.

12. A method of testing an optical network with a device, the method comprising:
recording an OTDR trace of the optical network with the device; and
performing an optical loss test on the optical network with the device, the optical loss test having an accuracy error of less than 0.1 dB.

13. The method of claim 12, wherein the device remains connected to the optical network between and during the steps of performing the trace and performing the loss test.

14. The method of claim 12, further comprising connecting an optical reflector to the optical network before performing the trace or the loss test, the optical reflector being connected to an opposite end of an optical fiber of the optical network as compared to the device.

15. The method of claim 14, wherein the optical reflector has a reflective loss no greater than 0.1 dB.

16. The method of claim 12, wherein performing at least one of the trace and loss test is performed using a laser driven by a pulse generator.

17. The method of claim 12, wherein the loss test is performed by transmitting a light into the optical network and measuring a power level of a reflected light using the device.

18. The method of claim 17, wherein loss of the optical network is determined by subtracting a measured power level of the reflected light from a reference power level and dividing the result of subtracting the measured power from the reference power by two.

19. The method of claim 19, wherein the reference power level is determined by:
connecting the device to an optical reflector;
transmitting light to the optical reflector; and
measuring a power level of a reflected light reflected by the optical reflector to the device.

20. The method of claim 12, further comprising performing a length test of the optical network with the device.
